(19) United States
(12) Patent Application Publication
(10) Pub. No.: US 2009/0188910 A1
(43) Pub. Date: Jul. 30, 2009

(54) Heat treatment system and method using active feedback

(75) Inventor: John Paul McDonnell, DeWitt, IA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/010,690

(22) Filed: Jan. 29, 2008

(51) Int. Cl. H05B 6/06

(52) U.S. Cl. 219/635; 219/660

(57) ABSTRACT

A method of heat treating a component is disclosed. The method may heat a first feature of the component and heat a second feature of the component differently than the first feature. The method may measure a temperature value of the first feature and of the second feature. The method may also compare the measured temperature values to a threshold temperature value. The method may modify the heating of at least one of the first and second features based on the comparison.

### TECHNICAL FIELD

The present disclosure relates generally to a heat treatment system and method and, more particularly, to a heat treatment system and method that uses active feedback.

### BACKGROUND

It is known to improve wear and fatigue characteristics of metal objects (e.g., a crankshaft, a gear, etc.) through material hardening. Material hardening includes at least two steps: heating and quenching. Heating includes raising the temperature of an object above a critical temperature. The term “critical temperature” may be defined as a temperature value that is sufficient to ensure material hardening when followed by quenching (e.g., an austenitizing temperature of 870 degrees Celsius for plain carbon steel). After the object exceeds the critical temperature, the object is rapidly cooled during a quenching process to material harden the object. One known method of heating objects is using a fuel fired furnace. Fuel furnace heat treatment has proven generally effective at heating large objects above the critical temperature. Induction heating and electrical resistance heating are examples of alternative heat treatment processes in which an electrical based heating element (e.g., an induction coil) is positioned near a selected portion of the object to produce localized heating. Electrical based heating has been implemented to selectively heat treat designated portions of an object that are routinely exposed to wear for surface hardening. Both fuel furnace heating and electrical based heating require quenching after the object has exceeded the critical temperature.

Furnace heating may suffer drawbacks that include emission of undesired pollutants (e.g., CO₂ or CO) and difficulty heat treating selected portions of an object. For example, furnace heating alone may not allow for accurate and selective heat treatment of designated portions of an object while avoiding heat treatment of non-designated portions of the same object. Furthermore, furnace heat treatment usually requires batch heating a large quantity of objects. Batch heating may be inefficient when custom objects or a limited quantity of similar objects need to be heat treated. Electrical based heat treatment may be suited for selective heat treatment, but electrical based heat treatment may provide insufficient heat transfer to material harden large or thick components. Furthermore, electrical based heat treatment may consume large amounts of labor to set-up and prepare an object for heating and/or quenching.

One example of an electrical based heating system used to heat irregular shaped objects is described in U.S. Pat. No. 4,447,690 (the '690 patent) to Grever. The '690 patent discloses an induction heating system including an induction preheating furnace having a power generating source and a means for positioning an irregular shaped object. The irregular shaped object may include large portions that require preheating, and relatively small portions that do not require preheating. To preheat the large portions, the '690 patent discloses selectively applying inductive heat using coils positioned near the large portions. After preheating the large portions, final heat treatment of the entire object is performed in a second furnace. Therefore, the '690 patent allows irregular shaped objects to be uniformly heated by selectively preheating large portions of the object using induction heating and then heating the entire object in a main furnace to a final uniform temperature.

Although the preheating method of the '690 patent may improve uniform heating of irregular shaped objects, it may be inefficient and have limited applicability. The '690 patent may be inefficient because it fails to precisely control heating of each portion. Without precise control over heating rates, the '690 patent may heat one portion of the object faster than a second portion during the induction preheating process, thereby causing excessive consumption of energy to ensure that both portions are sufficiently heated before moving to the final heating process, or it may cause excessive distortion in the object due to uneven heating. The '690 patent may have limited applicability because the '690 patent discloses heating the entire object in the main furnace to a uniform temperature. However, it may be desired to selectively material harden only certain portions of the object. Selective material hardening may be achieved by maintaining certain portions of the object below a critical hardening temperature or by selectively quenching only certain portions of the object. For example, during heat treatment for material hardening, it may be undesired to heat treat designated portions of an object that may need to be machined at a later point in time. Therefore, the '690 patent does not protect designated portions of the object from exceeding a critical temperature or from exposure to quenching material that enables material hardening.

The disclosed heat treatment system and method are directed to overcoming one or more of the problems set forth above.

### SUMMARY

In one aspect, the present disclosure is directed to a method of heat treating a component. The method may include heating a first feature of the component and heating a second feature of the component differently than the first feature. The method may further include measuring a temperature value of the first feature and of the second feature. The method may also include comparing the measured temperature values to a threshold temperature value. The method may further include modifying the heating of at least one of the first and second features based on the comparison.

In another aspect, the present disclosure is directed to a heat treatment system. The heat treatment system may include a power source, and a heater configured to receive power from the power source to heat a component. The heat treatment system may further include at least one sensor configured to measure a temperature value of a first feature of the component and a temperature value of a second feature of the component. The heat treatment system may also include a controller configured to receive a signal from the at least one sensor indicative of the measured temperature values of the first and second features, and modify heating of at least one of the first feature and the second feature.

### BRIEF DESCRIPTION OF THE DRAWINGS

FIG. 1 is a schematic illustration of an exemplary disclosed heat treatment system; and

FIG. 2 is a control diagram illustrating an exemplary method of operating the heat treatment system of FIG. 1.

### DETAILED DESCRIPTION

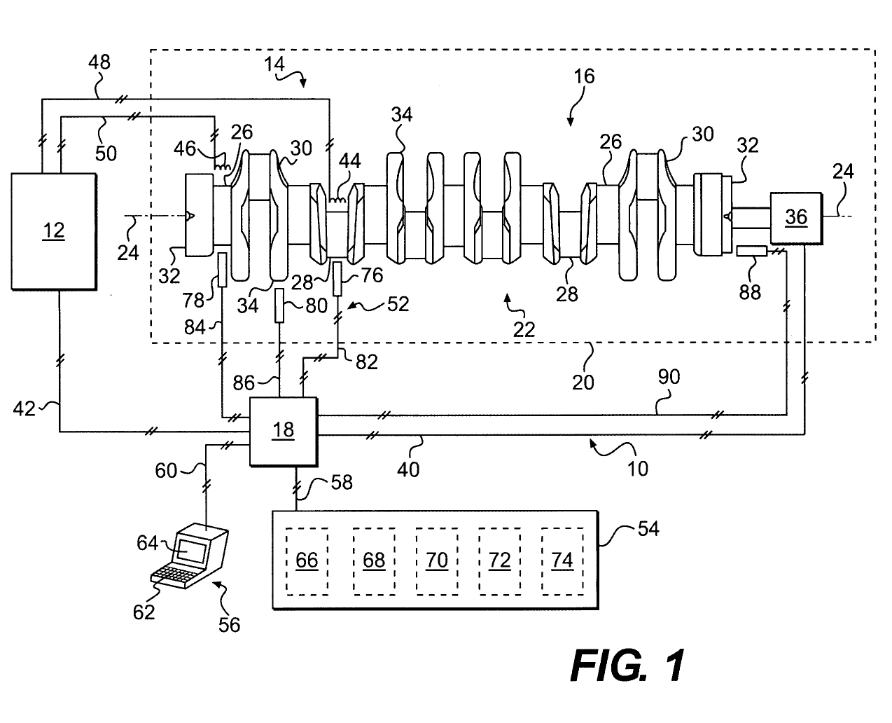

Referring to FIG. 1, a heat treatment system 10 may heat a machine component 16 held in place by a support structure 20. For this purpose, the heat treatment system 10 may include a power source 12 to supply power to a heater 14 to heat machine component 16. The heat treatment system 10 may further include a controller 18 to control operation of the power source 12 and the heater 14.

The machine component 16 may be any type of component that may be heat treated (e.g., for material hardening). In one example, the machine component 16 may have an irregular shape (i.e., non-uniform physical structure or varying material properties). In an exemplary embodiment, the machine component 16 may be a crankshaft 22 having a longitudinal axis 24. Although crankshaft 22 will be used as an exemplary embodiment in the detailed description, other types of machine components 16 (e.g., a gear) may benefit from the current heat treatment system and method. The crankshaft 22 may include various features defining an irregular shape extending along the longitudinal axis 24. These features may include one or more main journals 26, a plurality of pin journals 28, a plurality of webs 30, one or more end flanges 32, and at least one counterweight 34 associated with each pin journal 28. In the depicted example, the crankshaft 22 may include seven main journals 26, six pin journals 28, twelve webs 30, two end flanges 32, and twelve counterweights 34. It may be desirable to heat treat and material harden at least one feature 26-34 of the crankshaft 22 in order to improve the performance of the crankshaft 22 (e.g., wear resistance). For example, it may be desirable to material harden the main journals 26, pin journals 28, and webs 30. In contrast, it may be undesirable to material harden at least one feature 26-34 of the crankshaft 22. For example, it may be undesirable to harden the end flanges 32 and the counterweights 34. Thus, the crankshaft 22 may include a group of primary features that may be designated for heat treatment, and a group of secondary features that may not be designated for heat treatment. For purposes of explanation, the main journals 26, pin journals 28, and webs 30 are designated as primary features, and the end flanges 32 and the counterweights 34 are designated as secondary features. There may be various reasons why a feature may not be designated for heat treatment. For example, the end flanges 32 and the counterweights 34 may require additional machining that may be made more difficult if they are material hardened. Therefore, the features 26-34 may be either designated before the heat treatment process as primary features or designated as secondary features.

The support structure 20 may be any type of structure sufficient to maintain a predetermined spatial relationship between the heater 14 and the crankshaft 22. In an exemplary embodiment, the support structure 20 may hold the heater 14 and the crankshaft 22 in a fixed position relative to each other. For example, the heater 14 may be clamped on or near the primary features 26-30 of the crankshaft 22. In contrast, it may be desirable to impart movement between the heater 14 and the crankshaft 22 in order to provide uniform heat transfer to the primary features 26-30 of the crankshaft 22. It is contemplated that either the heater 14 or the crankshaft 22 may be fixed while the other is movable. In order to provide relative motion between the heater 14 and the crankshaft 22, the support structure 20 may include an actuator 36 for imparting motion to either the crankshaft 22 (as shown) or the heater 14 (not shown). The actuator 36 may receive control commands from the controller 18 via a communication line 40.

The power source 12 may include a power supply (e.g., AC power supply) that outputs electrical power to the heater 14. While only a single power source 12 is shown, a plurality of power sources 12 may be implemented, if desired. Control of the power source 12 may be implemented by commands received from the controller 18 via a communication line 42. Any known form of electrical-based heating may be used to heat the crankshaft 22. It is contemplated that the electrical heating may be induction heating and/or electrical resistance heating. In other words, power source 12 may implement induction heating alone, electrical resistance heating alone, or induction heating and electrical heating in combination for a single component. For purposes of explanation, only induction heating will be described in detail.

in an exemplary embodiment, the power source 12 may permit selective control of electrical power output (e.g., voltage, current, and frequency) directed to the heater 14 to the heat crankshaft 22. Using induction heating, the power source 12 may generate eddy currents, and resistance may lead to heating of the crankshaft 22. It is contemplated that the power source 12 may supply sufficient power to heat each of the primary features 26-30 past the critical hardening temperature to enable material hardening substantially throughout each of the primary features 26-30 and not merely along an outer surface.

The heater 14 may include at least one heating element for transferring heat to the crankshaft 22. The heater 14 may be an electrical-based heater, for example, an induction heater or an electrical resistance heater. In the exemplary induction heater shown in FIG. 1, an inductor may serve as the heating element. Hence, the heater 14 may include a first inductor 44 positioned proximate a designated primary component 26-30 of crankshaft 22 to receive electrical power from the power source 12 and heat the designated primary feature 26-30 of crankshaft 22. The first inductor 44 may be positioned at any point along the crankshaft 22 where heat treatment is desired. For example, the first inductor 44 may be positioned proximate one of the pin journals 28. It is contemplated that the heater 14 may include a plurality of inductors. For example, the heater 14 may also include a second inductor 46 positioned proximate one of the main journals 26. Although only two inductors 44, 46 are shown, the heater 14 may include any number of inductors to heat the crankshaft 22, if desired. It is contemplated that an inductor may be positioned proximate each of the primary feature 26-30 of the crankshaft 22.

The first and second inductors 44, 46 may be formed in the shape of coils and receive power from the power source 12 via supply lines 48, 50, respectively. For example, the first and second inductors 44, 46 may include fluid-cooled copper coils. The first and second inductors 44, 46 may be tailored to influence a desired heat treatment strategy based on their diameter, shape, number of turns, and relative proximity to each of the primary features 26-30 of the crankshaft 22.

in addition to communicating with the power source 12, the controller 18 may also communicate with a monitoring device 52, a memory storage device 54, and an operator interface device 56. For example, the controller 18 may initiate heat treatment based on a heat treatment strategy stored within the memory storage device 54 via communication line 58. During the heating process, the monitoring device 52 may sense the temperature of the features 26-34 of the crankshaft 22 and send signals indicative of their temperature to the controller 18. Following receipt of the temperature signals, the controller 18 may modify the heat control strategy when actual temperatures differ from desired temperatures. Additionally, the controller 18 may communicate with the operator interface device 56 via communication line 60. The operator interface device 56 may include an operator input device 62 (e.g. a keyboard, a mouse, etc.) and a display device 64 that facilitate manual control of the heat treatment process.

The memory storage device 54 may store heat treatment strategy values associated with the crankshaft 22. More specifically, the memory storage device 54 may include a uniform heat treatment strategy stored in a first data storage table 66, and a temperature threshold strategy stored in a second data storage table 68. The uniform heat treatment strategy may include a desired temperature range of values defining an acceptable level of uniform heating among each of the primary features 26-30 of the crankshaft 22. The temperature threshold strategy may define threshold values for each of the features 26-34 of the crankshaft 22. For example, each primary feature 26-30 may include a threshold value defining a critical temperature value to be exceeded during the heat treatment process. In contrast, each of the secondary features 32, 34 may include a threshold value defining a protected temperature value not to be exceeded during the heat treatment process.

Additionally, the memory storage device 54 may store heat treatment strategy values specific to each of the features 26-34 of the crankshaft 22. These heat treatment strategy values may be based on variables that influence the heat treatment process (e.g., induction interaction time, clearance distance between inductor and feature, voltage, current, and frequency). The individual heat treatment strategy values may be derived from research and testing of similar components. For example, each of the main journals 26 of the exemplary crankshaft 22 may include heat treatment strategy values stored in a third data storage table 70. Exemplary values for the third data storage table 70 may include an induction interaction time of about 85 seconds at a frequency of about 10 kHz. In contrast, a structurally or materially different primary feature 26-30 may include different heat treatment strategy values. For example, the pin journals 28 may include heat treatment strategy values stored in a fourth data storage table 72. Exemplary values for fourth data storage table 72 may include an induction interaction time of about 65 seconds at a frequency of about 20 kHz. The secondary features 32, 34, may not be designated for heat treatment and may only receive residual heat transferred from the neighboring primary features 26-30. Therefore, a heat treatment strategy for the secondary features 32, 34 may include avoiding direct heat to the secondary features 32, 34. Therefore, the memory storage device 54 may not include heat treatment strategy values for the secondary features 32, 34. It is contemplated that the controller 18 may initiate heat treatment of the crankshaft 22 using heat treatment strategy values stored in the memory storage device 54. If it is determined to be necessary, from feedback generated from the monitoring device 52, the controller 18 may modify the initial stored heat treatment strategy values by adjusting values for the variables (e.g., induction interaction time, clearance distance between inductor and feature, voltage, current, and frequency) stored in the memory storage device 54.

It is contemplated that motion control data may also be stored in the memory storage device 54 in a fifth data storage table 74. For example, the motion control strategy may include values for duration of motion (e.g., a start time and a stop time) and a speed value of the motion (e.g., 4 rotations per 60 seconds). Motion control values may be predetermined based on the specific characteristics of machine component 16. The motion control strategy may be determined during research and testing of a similar machine component. The controller 18 may access the memory storage device 54 to send command signals to the actuator 36 via the communication line 40 to impart relative motion between the crankshaft 22 and the heater 14 based on the stored motion control strategy.

The monitoring device 52 may sense temperature values of the features 26-34 of the crankshaft 22 and transmit signals indicative of feature temperatures to the controller 18. In order to ensure that the primary features 26-30 exceed the critical temperature that permit material hardening and the secondary features 32, 34 remain below the critical temperature, the monitoring device 52 may sense the temperature values of all of the features 26-34, including the primary features 26-30 and the secondary features 32, 34. For purposes of explanation, an exemplary monitoring device 52 may include a first temperature sensor 76 and a second temperature sensor 78 in communication with the controller 18 via communication lines 82, 84, respectively. The first temperature sensor 76 may be positioned proximate one of the pin journals 28, and the second temperature sensor 78 may be positioned proximate one of the main journals 26. Additionally, a third temperature sensor 80 may be positioned proximate one of the secondary features (e.g., counterweight 34) and communicate temperature data to the controller 18 via communication line 86, if desired. Although only three temperature sensors 76-80 are shown, the monitoring device 52 may include any number of temperature sensors to monitor the temperature of the features 26-34. For example, the monitoring device 52 may rely upon a single temperature sensor to provide representative temperature values of each of the pin journals 28 based on a measured temperature of a single pin journal 28.

The temperature sensors 76-80 may be any type of device capable of measuring or approximating an actual temperature of the crankshaft 22. For example, the temperature sensors 76-80 may be contact temperature sensors or non-contact temperature sensors. More specifically, the temperature sensors 76-80 may be thermocouple sensors or infrared sensors. It is contemplated that non-contact sensors, such as an infrared sensor, may be capable of sensing the value of a plurality of the features 26-34, simultaneously. Temperature value signals transmitted from the monitoring device 52 to the controller 18 may be used to update and optimize the initial heat treatment strategy values stored in the memory device 54. Further, temperature value signals transmitted from the monitoring device 52 to the controller 18 may be forwarded to the operator interface device 56 and displayed on the display device 64 for manual inspection and control.

The monitoring device 52 may also include a motion sensor 88. The motion sensor 88 may monitor relative motion between the crankshaft 22 and the heater 14. For example, the motion sensor 88 may be a position sensor or a speed sensor. Motion control value signals monitored by the motion sensor 88 may be transmitted to the controller 18 via a communication line 90. It is contemplated that the motion sensor 88 may be any type of known sensor capable of detecting the relative position or speed between two elements. The controller 18 may receive position data from the sensor 88 to determine if the speed or relative motion between the crankshaft 22 and the heater 14 need to be modified.

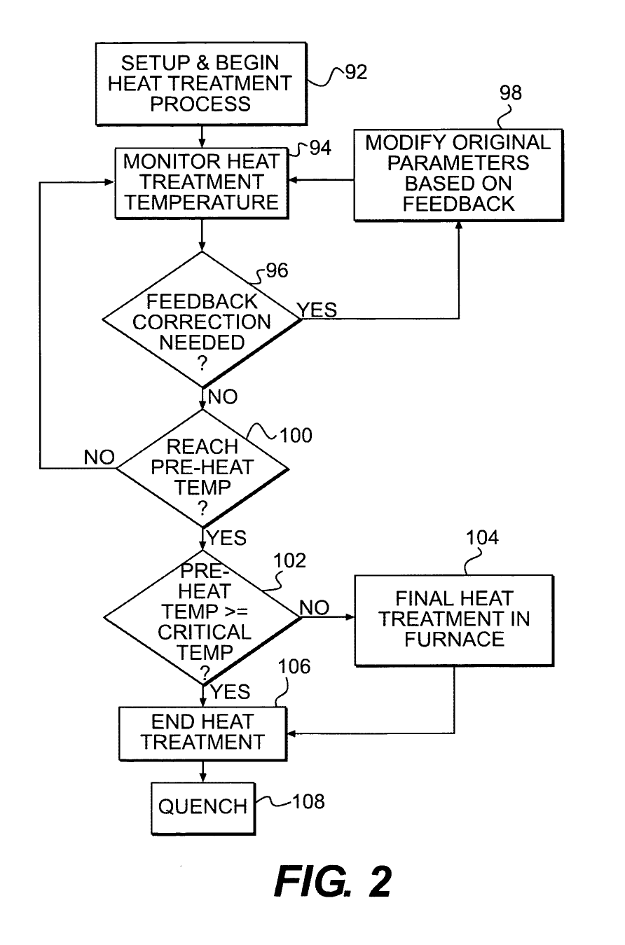

FIG. 2 shows a control diagram implementing a heat treatment strategy for imparting material hardening to designated primary features while minimizing hardening of designated secondary features. FIG. 2 will be discussed in detail in the following section.

### INDUSTRIAL APPLICABILITY

The disclosed heat treatment system may be used to heat machine components (e.g., for the purposes of material hardening). More specifically, the disclosed heat treatment system may be used to heat irregular shaped components using electrical based heating. Using active temperature monitoring and control, the disclosed heat treatment system may uniformly heat designated portions of the machine component and avoid directly heating non-designated portions of the machine component above a critical hardening temperature. Operation of the heat treatment system 10 will now be described.

After a specific machine component 16 (e.g., crankshaft 22) is selected for heat treatment, a determination may be made regarding which of the features 26-34 may be designated for heat treatment. For example, the primary features 26-30 may be designated for material hardening and the secondary features 32, 34 may not be designated for material hardening. An operator may manually set an initial heat treatment strategy for the crankshaft 22 using the operator interface device 56 or may rely upon the controller 18 to automatically implement an initial heat treatment strategy stored in the memory storage device 54.

Before the heat treatment process begins, the crankshaft 22 may be positioned relative to the heater 14 in the support structure 20. Once the crankshaft 22 is properly positioned, the heat treatment process may start. For example, the controller 18 may transmit signals indicative of an initial heat treatment strategy to the power source 12 based on heat treatment strategy data stored in the memory storage device 54 (Step 92). Additionally, if relative movement is required between the crankshaft 22 and the heater 14, the controller 18 may also command the actuator 36 to implement the motion control strategy stored in the fifth data storage table 74 of the memory storage device 54.

Throughout the heat treatment process, the monitoring device 52 may actively measure the temperature of at least one of the features 26-34 of the crankshaft 22 with the temperature sensors 76-80 (Step 94). Temperature data from the sensors 76-80 may be transmitted to the controller 18 for heat treatment strategy analysis and/or correction.

The controller 18 may determine if heat treatment strategy correction is needed based on at least one of two determinations (Step 96). First, the controller 18 may determine if the primary features 26-30 of the crankshaft 22 are being uniformly heated consistent with the uniform heat treatment strategy stored in the first data storage table 66 based on a comparison of the temperature difference of the primary features 26-30 at a given point in time. It may be desirable to uniformly heat each of the primary features 26-30 relative to a desired temperature range. For example, the first data storage table 66 may include a desired temperature range that all of the primary features 26-30 remain within about 50 degrees Celsius of each other during the heating process. If correction is needed, the initial heat treatment strategy may be modified (Step 98). For example, if it is determined based on measured temperature values from the first and second temperature sensors 76, 78 that one of the pin journals 28 is 570 degrees Celsius and one of the main journals 26 is 490 degrees Celsius, then the initial heat treatment strategy may be modified because the measured temperature difference of 80 degrees Celsius exceeds the desired temperature range of 50 degrees Celsius. Uniform heat treatment correction may include increasing heat transfer to the main journals 26 and/or decreasing heat transfer to the pin journals 28 to provide the measured temperature values of the primary features 26-30 inline with the desired temperature range of 50 degrees Celsius. It is contemplated that the desired temperature range may be more or less than 50 degrees Celsius. For example, the desired temperature range may be 10 degrees Celsius in order to provide more accurate heating control of the primary features 26-30.

Secondly, the controller 18 may also determine if heating of the crankshaft 22 is consistent with the temperature threshold strategy stored in the second data storage table 68. More specifically, the controller 18 may determine if the primary features 26-30 have exceeded a critical temperature value and if the secondary features 32, 34 have exceeded a protected temperature value. For example, the critical temperature value for the primary features 26-30 may be a temperature that enables material hardening (e.g., about 870 degrees Celsius for plain carbon steel). Therefore, it may be desired to monitor each of the primary features 26-30 to ensure that each exceeds the critical temperature. Additionally, a protected temperature value (e.g., about 700 degrees Celsius) for the secondary features 32, 34 may be a temperature that will not enable material hardening. Hence, it may be desired to monitor each of the secondary features 32, 34 to ensure that their measured temperature remains below the protected temperature. It is contemplated that the protected temperature value may include a buffer range (e.g., about 170 degrees Celsius) below the critical temperature value to help aid against hardening of the secondary features 32, 34. In other words, the protected temperature value may be less than the critical temperature value. In order to correct excessive temperatures of the secondary features 32, 34 that exceed the protected temperature, the heat treatment strategy of the primary features 26-30 may require modification to limit the residual heat that the secondary features 32, 34 receive from the neighboring primary features 26-30. For example, the controller 18 may command the power source 12 to supply less power to the heater 14 until the temperature of the secondary features 32, 34 drop below the protected temperature (Step 98).

Heat treatment using electrical based heating of the primary features 26-30 may continue until each of primary features 26-30 is uniformly heated above the critical temperature and each of the secondary features 32, 34 is measured to be below the protected temperature (Step 100). The monitoring device 52 may continuously monitor temperatures of the features 26-34 during the heat treatment process.

It is contemplated that electrical based heating alone may at times be insufficient to achieve the critical temperature of the primary features 26-30. In this situation, induction or electrical resistance heating may serve to pre-heat the crankshaft 22 to a pre-heat temperature (e.g., about 750 degrees Celsius). Therefore, the heat treatment process may require supplemental heat treatment to fully achieve the critical temperature (Step 102). Final heat treatment may be completed using a different type of heater. For example, final heat treatment may be completed in a fuel fired furnace (not shown) to raise the temperature of the primary features 26-30 from the pre-heat temperature to the critical temperature (Step 104). Once primary features 26-30 reach the critical temperature, the heating treatment process may be complete (Step 106).

After the critical temperature is exceeded by the primary features 26-30 and not exceeded by the secondary features 32, 34, material hardening may require quenching, a rapid cooling of the primary features 26-30 (Step 108). Assuming the temperature of the primary features 26-30 exceeds the critical temperature at the time of quenching, the quenching process may result in material hardening of the primary features 26-30. Assuming the temperature of the secondary features 32, 34 remains below the critical temperature at the time of the quenching, the quenching process may result in minimal material hardening of the secondary features 32, 34. It is contemplated that if the secondary features 32, 34 exceed the critical hardening temperature, for example, while being heated in the fuel fired furnace, selective quenching may be implemented to protect the secondary features 32, 34 from being material hardened. For example, selective quenching may be implemented by covering the secondary features 32, 34 during the quenching process or by focusing quenching material only at the primary features 26-30 such that the secondary features 32, 34 are not exposed to the quenching material. Hence, even if the secondary features 32, 34 exceed the critical hardening temperature, they may not be material hardened if they are not exposed to quenching material during the quenching process.

The heat treatment system 10 may reduce emission of pollutants found in traditional fuel furnace heating. Furnace heat treatment may serve to supplement the heat treatment process when induction or electrical resistance heat treatment alone are insufficient to heat a large or thick component. Further, heat treatment of selected portions of a component may be actively monitored to provide efficient heat treatment of designated portions while avoiding heat treatment of non-designated portions of the component. Additionally, the monitoring system 52 may provide feedback that allows irregular shaped features to be uniformly heat treated using various heat treatment strategies at substantially the same time which may serve to reduce labor expenses associated with heat treatment set-up. Maintaining the secondary features below the critical temperature at the time of quenching may reduce labor and expense involved in the quenching process because the entire crankshaft may be exposed to the quenching process. Therefore, additional labor tooling and equipment may not be required to protect the secondary features from the quenching process because their temperature may be monitored and controlled to remain below the critical temperature.

It will be apparent to those skilled in the art that various modifications and variations can be made to the disclosed system and method of heat treatment without departing from the scope of the disclosure. Other embodiments of the system and method of heat treatment will be apparent to those skilled in the art from consideration of the specification and practice of the heat treatment system disclosed herein. It is intended that the specification and examples be considered as exemplary only, with a true scope of the disclosure being indicated by the following claims and their equivalents.

What is claimed is:

1. A method of heat treating a component, comprising:
heating a first feature of the component;
heating a second feature of the component differently than the first feature;
measuring a temperature value of the first feature and of the second feature;
comparing the measured temperature values to a threshold temperature value; and
modifying the heating of at least one of the first and second features based on the comparison.

2. The method of claim 1, wherein heating the first feature includes selectively applying heat directly to the first feature, and heating the second feature includes selectively applying heat directly to the second feature.

3. The method of claim 2, wherein comparing the measured temperature values to the threshold temperature value includes determining if a temperature difference between the first temperature value and the second temperature value is within a desired temperature range.

4. The method of claim 3, wherein modifying the heating of at least one of the first and second features includes one of decreasing the heat applied to the first feature and increasing the heat applied to the second feature to reduce a temperature difference between the first and second features to within the desired temperature range.

5. The method of claim 3, wherein modifying the heating of at least one of the first and second features includes both decreasing the heat applied to the first feature and increasing the heat applied to the second feature to reduce a temperature difference between the first and second features to within the desired temperature range.

6. The method of claim 1, wherein heating the first feature includes applying heat directly to the first feature, and heating the second feature includes applying heat indirectly through the first feature.

7. The method of claim 6, wherein comparing the measured temperature values to a threshold temperature value includes determining if the first feature is above a critical temperature value and if the second feature is below a protected temperature value.

8. The method of claim 7, wherein modifying the heating of at least one of the first and second features includes reducing heat applied to the first feature when the second feature is above the protected temperature value.

9. The method of claim 7, further including rapidly cooling the first feature and the second feature when the first feature is above the critical temperature value and the second feature is below the protected temperature value, wherein the protected temperature is less than the critical temperature.

10. The method of claim 7, wherein the critical temperature value is sufficient to enable material hardening of the first feature.

11. The method of claim 10, wherein the critical temperature value is sufficient to enable material hardening substantially throughout the first feature.

12. The method of claim 1, wherein heating the first feature and the second feature includes heating by electrical heating.

13. The method of claim 12, wherein electrical heating the first feature and the second feature includes induction heating.

14. The method of claim 12, wherein electrical heating the first feature and the second feature includes electrical resistance heating.

15. A heat treatment system, comprising:
a power source;
a heater configured to receive power from the power source to heat a component;
at least one sensor configured to measure a temperature value of a first feature of the component and a temperature value of a second feature of the component; and
a controller configured to receive a signal from the at least one sensor indicative of the measured temperature values of the first and second features and to modify heating of at least one of the first feature and the second feature based on the signal.

16. The heat treatment system of claim 15, wherein the at least one sensor includes a first temperature sensor configured to measure the temperature value of the first feature and a second temperature sensor configured to measure the temperature value of the second feature.

17. The heat treatment system of claim 16, wherein the heater includes a first heating element configured to heat the first feature, and a second heating element configured to heat the second feature.

18. The heat treatment system of claim 16, wherein the heater is configured to directly heat the first feature and indirectly heat the second feature.

19. A method of heat treating a component, comprising:
heating a first feature and a second feature of the component using electrical heating;
measuring a first temperature value of the first feature and a second temperature value of the second feature;
comparing the measured first and second temperature values to a pre-heat temperature value;
heating the component above a critical temperature using fuel fired furnace heating when at least the first temperature value exceeds the pre-heat temperature value; and
rapidly cooling the first feature with a cooling material such that material hardening occurs in the first feature and material hardening does not occur in the second feature.

20. The method of claim 19, further including:
protecting the second feature from exposure to the cooling material.
